(19) United States
(12) Patent Application Publication
(10) Pub. No.: US 2012/0076185 A1
(43) Pub. Date: Mar. 29, 2012

(54) APPARATUS AND METHOD FOR COMPENSATING TRANSMISSION POWER IN WIRELESS COMMUNICATION TERMINAL

(75) Inventors: Dae-Woo Park, Seoul (KR); Yu-Mi Hong, Anyang-si (KR)

(73) Assignee: SAMSUNG ELECTRONICS Co., LTD., Suwon-si (KR)

(21) Appl. No.: 13/187,366

(22) Filed: Jul. 20, 2011

(30) Foreign Application Priority Data
Sep. 27, 2010 (KR) 10-2010-0093241

(51) Int. Cl. H04W 52/04

(52) U.S. Cl. 375/222

(57) ABSTRACT

Provided are an apparatus and method for compensating transmission power of a signal transmitted through a slave modem (e.g., a WiMAX modem) in a wireless communication terminal including a dual modem. A slave modem receives a digital code value corresponding to a periodically measured battery voltage value from a host modem through a General Purpose Input Output (GPIO) port. The slave modem determines a transmission power compensation value corresponding to the received digital code value from a predefined table.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Sep. 27, 2010 and assigned Serial No. 10-2010-0093241, the contents of which are incorporated herein by reference.

### TECHNICAL FIELD OF THE INVENTION

The present invention relates generally to an apparatus and method for compensating transmission power in a wireless communication terminal, and more particularly, to an apparatus and method for compensating transmission power of a signal transmitted through a slave modem (e.g., a WiMAX modem) in a wireless communication terminal including a dual modem.

### BACKGROUND OF THE INVENTION

In general, wireless communication systems have been primarily developed for voice services and are evolving to provide data services and various multimedia services as well as voice services. However, because wireless communication systems, which are mainly directed to providing voice communication services, are relatively narrow in transmission bandwidth and are high in service rate, they cannot meet a rapid increase of user demands. Furthermore, the development in the communication industry and the ever-increasing user demands on Internet services increases the demand for wireless communication systems that can provide efficient Internet services. These trends have led to the introduction of broadband wireless access systems that have enough bandwidth to meet the increasing user demands and provide efficient Internet services.

The broadband wireless access systems support voice services, a variety of low-speed and high-speed data services, and multimedia application services, such as high-quality moving picture services. Such broadband wireless access systems may access Public Switched Telephone Network (PSTN), Public Switched Data Network (PSDN), Internet network, IMT2000 network, or Asynchronous Transfer Mode (ATM) network in mobile or fixed environment based on wireless medium using a broadband (e.g., 2 GHz, 5 GHz, 26 GHz, and 60 GHz, and so forth), and support a channel transmission rate of 2 Mbps or more. The broadband wireless access systems may be classified as a broadband wireless subscriber network, a broadband mobile access network, and a high-speed wireless Local Area Network (LAN), depending on mobility (fixed or moving state) of a terminal, communication environment (indoor or outdoor), and a channel transmission rate.

A wireless access scheme of the broadband wireless access system is under discussion for standardization in the international standardization organization. A WiMAX system, one of the broadband wireless access systems, is under discussion for standardization in the Institute of Electrical and Electronics Engineers (IEEE) 802.16 standardization group. As compared to a wireless technique for a conventional voice service, the IEEE 802.16 standard has a wide data bandwidth and thus can transmit a large amount of data in a short time, and allows all users to share channels (or resources), leading to the efficient use of the channels. In addition, the IEEE 802.16 standard ensures Quality of Service (QoS) and thus allows users to receive services with different QoS according to characteristics of services.

In general, a call quality is poor when transmission power of a wireless communication terminal is reduced, and is excellent when transmission power of a wireless communication terminal is increased. Therefore, it is necessary to output a stable transmission power in order to maintain excellent call quality and maximize capacity. In particular, a WiMAX system requires a stable transmission power in order to maximize a transmission capacity.

A currently implemented technique supplies power of a Power Amplifier Module (PAM) directly from a battery or supplies power of a PAM using a booster or a DC/DC converter.

If the power of the PAM is supplied directly from the battery, transmission power lower than required by a provider is output due to a voltage drop of the battery, making it difficult to achieve a smooth data communication. If the power of the PAM is supplied using the booster or the DC/DC converter, a stable transmission power can be output, without regard to the voltage drop of the battery. However, an additional hardware configuration is required, and thus, there is a limitation in terms of space and costs.

### SUMMARY OF THE INVENTION

To address the above-discussed deficiencies of the prior art, a primary aspect of the present invention is to substantially solve at least the above problems and/or disadvantages and to provide at least the advantages below. Accordingly, an object of the present invention is to provide an apparatus and method for compensating transmission power in a wireless communication terminal.

Another object of the present invention is to provide an apparatus and method for compensating transmission power of a signal transmitted through a slave modem (e.g., a WiMAX modem) in a wireless communication terminal including a dual modem.

Another object of the present invention is to provide an apparatus and method for constantly maintaining transmission power of a signal transmitted through a slave modem (e.g., a WiMAX modem) in a software manner in a wireless communication terminal including a dual modem, without additional hardware configurations.

Another object of the present invention is to provide an apparatus and method for compensating transmission power in a wireless communication terminal including a dual modem, wherein General Purpose Input Output (GPIO) ports are added to a host modem and a slave modem (e.g., a WiMAX modem), the host modem provides a periodically measured battery voltage value to the slave modem through the GPIO port, and the slave modem compensates the transmission power according to the battery voltage value received through the GPIO port.

According to an aspect of the present invention, a method for compensating transmission power of a slave modem in a wireless communication terminal including a dual modem is provided. A digital code value corresponding to a periodically measured battery voltage value is received by a slave modem from a host modem through a General Purpose Input Output (GPIO) port. A transmission power compensation value corresponding to the received digital code value is determined by the slave modem from a predefined table.

According to another aspect of the present invention, an apparatus for compensating transmission power of a slave modem in a wireless communication terminal including a dual modem is provided. The apparatus includes a host modem and a slave modem. The host modem transmits a digital code value corresponding to a periodically measured battery voltage value through a General Purpose Input Output (GPIO) port to a slave modem. The slave modem receives the digital code value corresponding to the battery voltage value from the host modem through a GPIO port, and determines a transmission power compensation value corresponding to the received digital code value from a predefined table.

According to yet another aspect of the present invention, a method for compensating transmission power of a slave modem in a wireless communication terminal including a dual modem is provided. A battery voltage value is measured periodically by a battery voltage value measurer. A digital code value corresponding to the periodically measured battery voltage value is transmitted by a host modem to a slave modem. A transmission power compensation value corresponding to the digital code value is determined by the slave modem from a predefined table.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a process for compensating transmission power of a signal transmitted through a slave modem (e.g., a WiMAX modem) in a wireless communication terminal including a dual modem according to an embodiment of the present invention;

FIG. 2 is a block diagram of a wireless communication terminal including a dual modem according to an embodiment of the present invention;

FIG. 3 illustrates a process for operating a host modem to compensate transmission power of a signal transmitted through a slave modem (e.g., a WiMAX modem) in a wireless communication terminal including a dual modem according to an embodiment of the present invention; and

FIG. 4 illustrates a process for operating a slave modem to compensate transmission power of a signal transmitted through a slave modem (e.g., a WiMAX modem) in a wireless communication terminal including a dual modem according to an embodiment of the present invention.

### DETAILED DESCRIPTION OF THE INVENTION

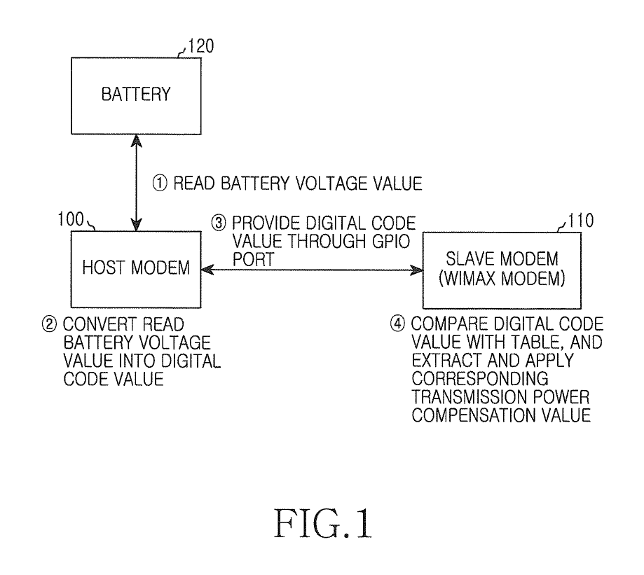

FIGS. 1 through 4 discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication terminal.

Hereinafter, an apparatus and method for compensating transmission power in a wireless communication terminal will be described. In particular, an apparatus and method for compensating transmission power of a signal transmitted through a slave modem (e.g., a WiMAX modem) in a wireless communication terminal including a dual modem will be described.

In the following description, the wireless communication terminal includes a dual modem, in which a host modem provides a periodically measured battery voltage value to a slave modem through a General Purpose Input Output (GPIO) port, and the slave modem compensates transmission power according to the battery voltage value received through a GPIO port. In the following embodiments of the present invention, a WiMAX modem will be taken as an example of the slave modem. However, it is apparent that the present invention can be applied to any type of modems requiring a stable transmission power output.

Moreover, although the wireless communication terminal including the dual modem will be taken as an example, it is apparent that the present invention can also be equally applied to a multi-modem wireless communication terminal including two or more modems.

FIG. 1 is a block diagram of a process for compensating transmission power of a signal transmitted through a slave modem (e.g., a WiMAX modem) in a wireless communication terminal including a dual modem according to an embodiment of the present invention.

Referring to FIG. 1, the wireless communication terminal includes a host modem 100 and a slave modem (e.g., a WiMAX modem) 110, which transmit and receive signals through GPIO ports.

The host modem 100 reads a periodically measured voltage value of a battery 120, converts the read battery voltage value into a digital code value, and provides the digital code value to the slave modem 110 through the GPIO port. In this manner, the host modem 100 informs the slave modem 110 of the read battery voltage value.

The slave modem 110 compares a predefined table with the digital code value received from the host modem 100 through the GPIO port, extracts a transmission power compensation value corresponding to the digital code value, and applies the extracted transmission power compensation value to compensate transmission power of a signal transmitted through the slave modem 110.

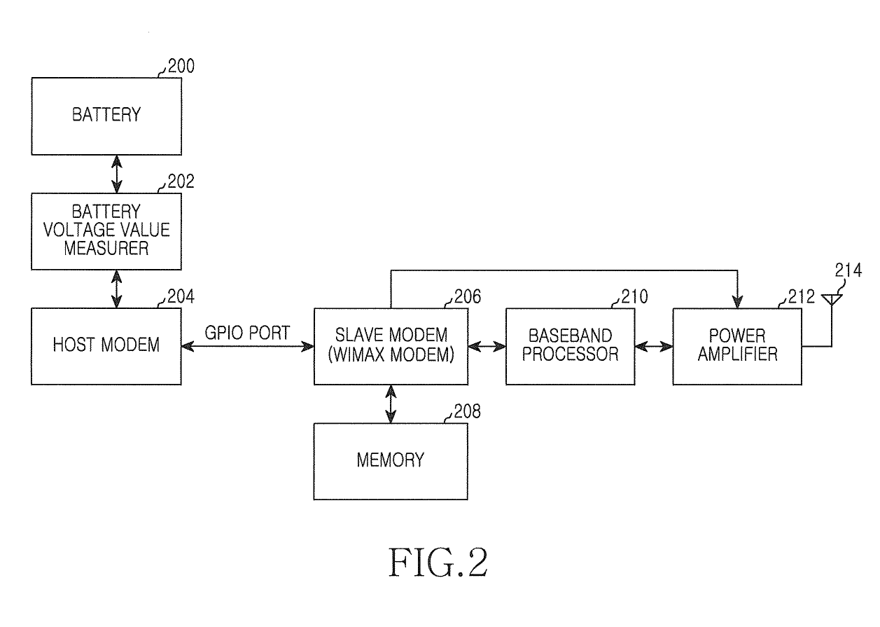

FIG. 2 is a block diagram of the wireless communication terminal including the dual modem according to the embodiment of the present invention.

As illustrated in FIG. 2, the wireless communication terminal including the dual modem includes a battery 200, a battery voltage value measurer 202, a host modem 204, a slave modem 206, a memory 208, a baseband processor 210, a power amplifier 212, and an antenna 214.

Referring to FIG. 2, the battery voltage value measurer 202 periodically measures a voltage value of the battery 200.

The host modem 204 modulates or demodulates a signal transmitted or received through a corresponding antenna (not shown). In addition to a typical function, the host modem 204 reads the battery voltage value periodically measured by the battery voltage value measurer 202, and determines whether the read battery voltage value is less than a reference value. If it is determined that the read battery voltage value is less than the reference value, the host modem 204 converts the read battery voltage value into a digital code value and provides the digital code value to the slave modem 206 through the GPIO port.

The slave modem 206 modulates or demodulates a signal transmitted or received through the corresponding antenna 214. In addition to a typical function, if the digital code value corresponding to the battery voltage value periodically measured by the battery voltage value measurer 202 is received from the host modem 204 through the GPIO port, the slave modem 206 compares the received digital code value with a predefined table, extracts a transmission power compensation value corresponding to the digital code value from the table, and provides the extracted transmission power compensation value to the power amplifier 212.

The memory 208 stores the table in which transmission power compensation values for digital code values are mapped.

The baseband processor 210 baseband-processes a signal transmitted or received between the slave modem 206 and the power amplifier 212. For example, upon transmission, the baseband processor 210 channel-codes and spreads data to be transmitted. Upon reception, the baseband processor 210 despreads and channel-decodes a received signal.

The power amplifier 212 RE-processes a signal transmitted or received between the baseband processor 210 and the antenna 214. For example, the power amplifier 212 power-amplifies an RF transmit/receive signal, converts the RF signal into the baseband signal, and converts the baseband signal into the RF signal. In addition, if the transmission power compensation value is provided from the slave modem 206, the power amplifier 212 compensates transmission power of a signal transmitted through the antenna 214 connected to the power amplifier 212 by applying the received transmission power compensation value upon the power amplification.

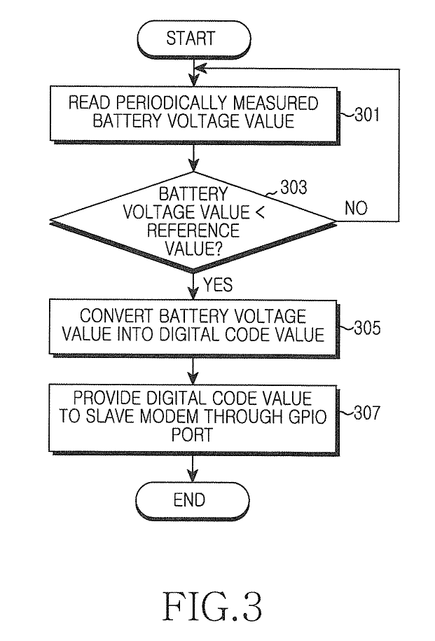

FIG. 3 illustrates a process for operating a host modem to compensate transmission power of a signal transmitted through a slave modem (e.g., a WiMAX modem) in a wireless communication terminal including a dual modem according to an embodiment of the present invention.

Referring to FIG. 3, a host modem reads a battery voltage value periodically measured by a battery voltage value measurer in block 301.

To determine whether it is necessary to compensate transmission power of a signal transmitted through a slave modem (e.g., a WiMAX modem), the host modem determines whether the read battery voltage value is less than a reference value in block 303.

If it is determined in block 303 that the read battery voltage value is equal to or greater than the reference value, the host modem determines that it is unnecessary to compensate the transmission power of the signal transmitted through the slave modem, and returns to block 301 to perform the subsequent blocks.

On the other hand, if it is determined in block 303 that the read battery voltage value is less than the reference value, the host modem determines that it is necessary to compensate the transmission power of the signal transmitted through the slave modem, and converts the read battery voltage value into a digital code value in block 305.

In block 307, the host modem provides the digital code value to the slave modem through the GPIO port in order to notify the read battery voltage value.

Then, the host modem ends the algorithm according to the embodiment of the present invention.

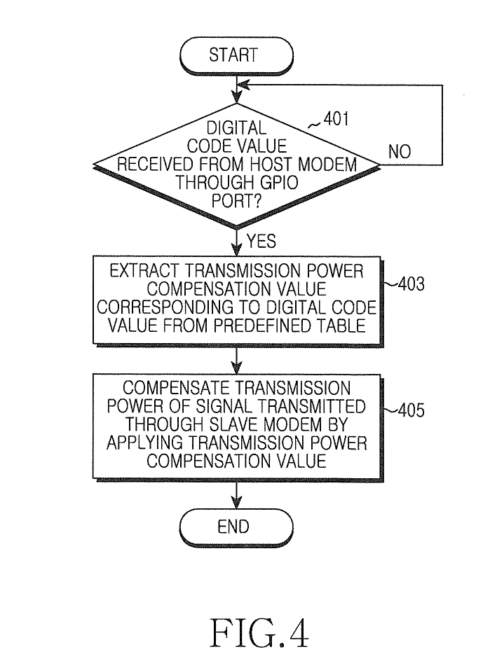

FIG. 4 illustrates a process for operating a slave modem to compensate transmission power of a signal transmitted through a slave modem (e.g., a WiMAX modem) in a wireless communication terminal including a dual modem according to an embodiment of the present invention.

Referring to FIG. 4, a slave modem determines whether a digital code value corresponding to a battery voltage value periodically measured by a battery voltage value measurer is received from a host modem through a GPIO port in block 401.

If it is determined in block 401 that the digital code value is received from the host modem through the GPIO port, the slave modem compares the received digital code value with a predefined table and extracts a transmission power compensation value corresponding to the digital code value from the table in block 403. The table may be predefined as a table in which transmission power compensation values for digital code values are mapped.

In block 405, the slave modem compensates transmission power of a signal transmitted through the slave modem by applying the extracted transmission power compensation value. In this manner, the signal transmitted through the slave modem may be transmitted with the compensated transmission power through an antenna.

Then, the slave modem ends the algorithm according to the embodiment of the present invention.

As described above, in the wireless communication terminal including the dual modem, the GPIO ports are added to the host modem and the slave modem (e.g., the WiMAX modem). The battery voltage value periodically measured by the host modem is provided to the slave modem through the GPIO port, and the slave modem compensates the transmission power according to the battery voltage value received through the GPIO port. Hence, according to an embodiment of the present invention, the transmission power of the signal transmitted through the WiMAX modem may be constantly maintained in a software manner, without additional hardware configurations. Moreover, because additional hardware configurations are not needed, space and costs may be reduced.

Although the present disclosure has been described with embodiments, various changes and modifications may be suggested to one skilled in the art. It is intended that the present disclosure encompass such changes and modifications as fall within the scope of the appended claims.

What is claimed is:

1. A method for compensating transmission power of a slave modem in a wireless communication terminal including a dual modem, the method comprising:
receiving, by a slave modem, a digital code value corresponding to a periodically measured battery voltage value from a host modem through a General Purpose Input Output (GPIO) port; and
determining, by the slave modem, a transmission power compensation value corresponding to the received digital code value from a predefined table.

2. The method of claim 1, further comprising compensating, by a power amplifier, transmission power of a signal transmitted through the slave modem by applying the determined transmission power compensation value.

3. The method of claim 1, further comprising:
measuring, by a battery voltage value measurer, a battery voltage value periodically;
reading, by the host modem, the periodically measured battery voltage value;
determining, by the host modem, whether the battery voltage value is less than a reference value;
converting, by the host modem, the battery voltage value into a digital code value when the battery voltage value is less than the reference value; and
providing, by the host modem, the converted digital code value to the slave modem through the GPIO port.

4. The method of claim 1, wherein the slave modem comprises a WiMAX modem.

5. The method of claim 1, wherein the predefined table is a table in which transmission power compensation values for digital code values are mapped to corresponding digital code values.

6. The method of claim 3, further comprising determining that the transmission compensation value is not needed when the battery voltage value is not less than the reference value.

7. An apparatus for compensating transmission power of a slave modem in a wireless communication terminal including a dual modem, the apparatus comprising:
a host modem configured to transmit a digital code value corresponding to a periodically measured battery voltage value through a General Purpose Input Output (GPIO) port to a slave modem; and
a slave modem configured to receive the digital code value corresponding to the battery voltage value from the host modem through a GPIO port, and determine a transmission power compensation value corresponding to the received digital code value from a predefined table.

8. The apparatus of claim 7, further comprising a power amplifier for compensating transmission power of a signal transmitted through the slave modem by applying the determined transmission power compensation value.

9. The apparatus of claim 7, further comprising a battery voltage value measurer for measuring a battery voltage value periodically,
wherein the host modem is further configured to read the periodically measured battery voltage value, determine whether the read battery voltage value is less than a reference value, convert the battery voltage value into the digital code value when the battery voltage value is less than the reference voltage.

10. The apparatus of claim 7, wherein the slave modem comprises a WiMAX modem.

11. The apparatus of claim 7, further comprising a memory configured to store a table in which transmission power compensation values are mapped to digital code values.

12. The apparatus of claim 7, wherein the host modem is further configured to transmit the digital code value to the slave modem when the battery voltage value is less than the reference voltage.

13. The apparatus of claim 9, wherein the host modem is further configured to determine that the transmission compensation value is not needed when the battery voltage value is not less than the reference value.

14. A method for compensating transmission power of a slave modem in a wireless communication terminal including a dual modem, the method comprising:
measuring, by a battery voltage value measurer, a battery voltage value periodically;
transmitting, by a host modem, a digital code value corresponding to the periodically measured battery voltage value to a slave modem; and
determining, by the slave modem, a transmission power compensation value corresponding to the digital code value from a predefined table.

15. The method of claim 14, further comprising compensating, by a power amplifier, transmission power of a signal transmitted through the slave modem by applying the determined transmission power compensation value.

16. The method of claim 14, further comprising:
reading, by the host modem, the periodically measured battery voltage value;
determining, by the host modem, whether the battery voltage value is less than a reference value; and
converting, by the host modem, the battery voltage value into a digital code value when the battery voltage value is less than the reference value,
wherein the digital code value is transmitted to the slave modem when the battery voltage value is less than the reference value.

17. The method of claim 14, wherein the slave modem comprises a WiMAX modem.

18. The method of claim 14, wherein the predefined table is a table in which transmission power compensation values for digital code values are mapped to corresponding digital code values.

19. The method of claim 16, further comprising determining that the transmission compensation value is not needed when the battery voltage value is not less than the reference value.

20. The method of claim 14, wherein the digital code value is transmitted to the slave modem through a General Purpose Input Output (GPIO) port.
